(19) United States
(12) Patent Application Publication
(10) Pub. No.: US 2016/0270300 A1
(43) Pub. Date: Sep. 22, 2016

(54) GARDEN EDGER

(71) Applicant: Marlene Isaacson, Farmington, MN (US)

(72) Inventor: Marlene Isaacson, Farmington, MN (US)

(21) Appl. No.: 14/660,088

(22) Filed: Mar. 17, 2015

(51) Int. Cl. A01G 3/06

(52) U.S. Cl. CPC A01G 3/06

(57) ABSTRACT

A garden edger that includes: a vertical pole; a horizontal cross pole at the top of the vertical pole; a footplate at the bottom of the vertical pole; and a blade extending from the bottom of the footplate. The blade includes a top edge and a bottom edge, where the top edge attaches to the bottom of the footplate and the bottom edge is a cutting edge. Preferably, the top edge has a first length and the bottom edge has a second length, where the first length is greater than the second length. Further, the horizontal cross pole may extend into a first vertical plane and the blade extends into a second vertical plane, where the first vertical plane is perpendicular to the second vertical plane. Also, the blade preferably extends at a 90-degree angle from the footplate.

### BACKGROUND OF THE INVENTION

1. Field of Invention

The present invention relates to a gardening tool used for edging a lawn.

2. Description of Related Art

Various types of gardening tools are used by gardeners to accomplish various tasks associated with the gardening and associated lawn area. Some of these gardening tools include various types of shovels, picks, clippers and other small hand tools that are used to work in a garden. Many of the tools relate to movement of dirt and other tools related to the cutting or trimming of plants, bushes or grass in a garden. One of the common tasks associated with gardening is the edging of the lawn border that provides a neat and crisp look to a garden. Particularly most gardeners use a tool that helps the user to firmly and accurately edge the lawn to avoid the overflow of grass onto concrete or pavement areas. Further, edgers were occasionally needed to separate or demark the border of the lawn for any flower or plant bed area that may be in the garden. The edging process sometimes can be difficult if proper tooling is not provided to crisply edge the lawn.

### SUMMARY OF THE INVENTION

The present invention relates to a garden edger comprising: a vertical pole; a horizontal cross pole at the top of the vertical pole; a footplate at the bottom of the vertical pole; and a blade extending from the bottom of the footplate. The blade includes a top edge and a bottom edge, where the top edge attaches to the bottom of the footplate and the bottom edge is a cutting edge. Preferably, the top edge has a first length and the bottom edge has a second length, where the first length is greater than the second length. Further, the horizontal cross pole may extend into a first vertical plane and the blade extends into a second vertical plane, where the first vertical plane is perpendicular to the second vertical plane. Also, the blade preferably extends at a 90-degree angle from the footplate.

### BRIEF DESCRIPTION OF DRAWINGS

FIG. 1 depicts a side view of a garden edger in accordance with the present invention.

FIG. 2 depicts an opposing side view of the garden edger in accordance with the present invention.

FIG. 3 depicts a foot plate used in conjunction with the garden edger in accordance with the present invention.

### DETAILED DESCRIPTION

The present invention relates to a garden edger that is used to edge a lawn. The garden edger, according to the present invention, includes an elongated pole with a cross pole creating a handle at the top of the elongated pole. At the bottom of the elongated pole a foot plate is provided to allow the user to apply pressure of the foot and weight of the user onto a blade that is attached to the bottom edge of the foot plate. The blade maintains a vertical position perpendicular to the footplate. The footplate surface expands beyond the edges of the blade and allows the user to apply foot pressure while holding the handle in order to edge the garden or the lawn.

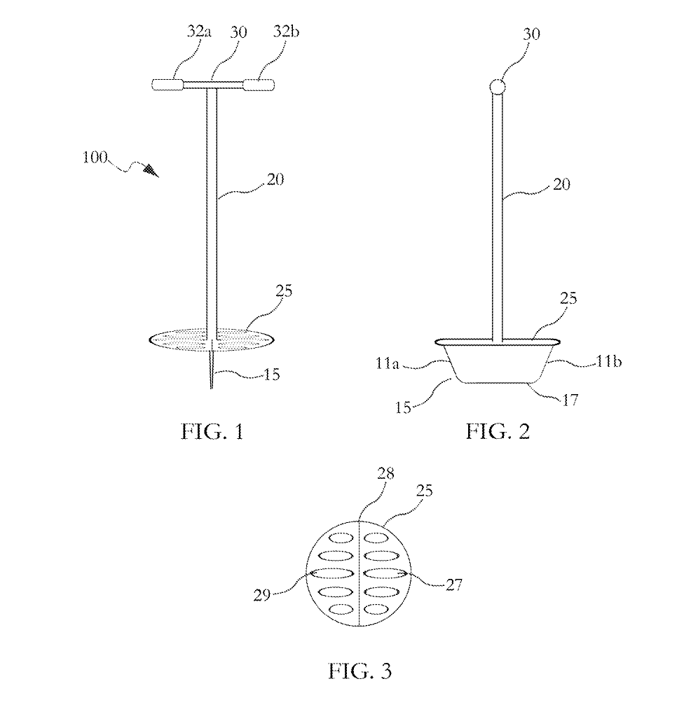

In reference to FIG. 1, a front side view of a garden edger 100 in accordance with the present invention as depicted. In this particular view, as shown, a pole 20 includes a cross pole 30 at the top of the pole 20 and a footplate 25 at the bottom of the pole 20. Cross pole 30 includes handles 32a, 32b at each respective end of the cross pole 30. At the bottom of the pole 20 is the footplate 25 that is circular and includes a circular surface area that surrounds the pole 20. Below the circular area and footplate 25, a blade 15 extends. The blade 15 is shown at a side view angle, which depicts only a thin side of the blade, which is shown as side 11a in FIG. 2. At this particular angle, the handle 30 is perpendicular to the pole 20 in a first horizontal plane. Further the surface area of the footplate 25 is also perpendicular to the pole 20. In parallel with the pole 20 is the blade 15. When in this particular angle the user may easily apply pressure by placing of their feet onto the footplate 25 to depress the blade 15 into the ground. Once depressed into the ground the blade 15 creates an edge for the lawn as desired. An alternative view is provided in FIG. 2, where the garden edger 100 is turned at a 90-degree angle about an axis traveling through the center of the pole 20. This alternative view shows the full length of the blade 15. As shown in FIG. 2, the cross pole 30 is at a perpendicular vertical plane in relation to the blade 15. The blade 15 includes a cutting edge 17 and two sides 11a, 11b. The top edge of the blade 15 is attached to the footplate 25. The top edge has a first length and the bottom edge 17 with a cutting edge has a second length. This creates an angle for each side 11a, 11b as configured.

FIG. 3 depicts a top view of the footplate 25. As shown, the footplate 25 has a centerline 28 with a series of openings on each respective side of the centerline 28. A first series of openings 29 are depicted on a first side of the centerline 28 and then a second series of openings 27 are shown on a second side of the centerline 28. These series of openings have varying sizes. The mid opening provides the largest opening and the opening sizes decrease, as the openings are closer to the perimeter of the footplate 25. Further each opening is ecliptically shaped. The openings allow for the user to use the footplate 25 in a manner, where a great deal of debris or dirt does not interfere with the application of pressure onto the footplate 25. This debris or dirt may easily fall through the openings provided on the footplate 25 during use.

The present invention creates an edger that is effective to use and preferably has a suitable height associated with the pole 20 to make the use of the garden edger effective. In one particular embodiment, the pole is approximately 40 inches in height, although this height may vary based upon the desired application. The instant invention has been shown and described in what it considers to be the most practical and preferred embodiments. It is recognized, however, that departures may be made there from within the scope of the invention and that obvious modifications will occur to a person skilled in the art.

1. A garden edger comprising:
a) a vertical pole;
b) a horizontal cross pole at the top of the vertical pole;
c) a footplate at the bottom of the vertical pole, wherein the vertical pole extends from the center of the footplate and the footplate includes a centerline, a first side of the centerline and a second side of the centerline, where the first side includes a first series of openings and the second side includes a second series of openings, wherein said first series of openings and second series of openings are adapted to prevent accumulation of debris onto the footplate during use thereof; and
d) a blade extending from the bottom of the footplate.

2. The garden edger according to claim 1, where the blade includes a top edge and a bottom edge, where the top edge attaches to the bottom of the footplate and the bottom edge is a cutting edge.

3. The garden edger according to claim 2, where the top edge has a first length and the bottom edge has a second length.

4. The garden edger according to claim 3, where the first length is greater than the second length.

5. The garden edger according to claim 1, where the horizontal cross pole extends into a first vertical plane and the blade extends into a second vertical plane, where the first vertical plane is perpendicular to the second vertical plane.

6. The garden edger according to claim 1, where the blade extends at a 90-degree angle from the footplate.

7. (canceled)

8. (canceled)

9. The garden edger according to claim 8, where the first series of openings vary in size.

10. The garden edger according to claim 9, where the first series of openings decrease in size from a center opening to a perimeter opening.

11. The garden edger according to claim 8, where the second series of openings vary in size.

12. The garden edger according to claim 9, where the second series of openings decrease in size from a center opening to a perimeter opening.
